(19) United States
(12) Patent Application Publication
(10) Pub. No.: US 2026/0368960 A1
(43) Pub. Date: Nov. 19, 2026

(54) METHOD, APPARATUS, DEVICE, MEDIUM, AND PROGRAM PRODUCT FOR GENERATING AND PLAYING PANORAMIC VIDEO

(71) Applicant: Beijing Zitiao Network Technology Co., Ltd., Beijing (CN)

(72) Inventor: Haitao Liu, Beijing (CN)

(21) Appl. No.: 19/126,241

(22) PCT Filed: Mar. 6, 2024
(86) PCT No.: PCT/CN2024/080402

§ 371 Date: Apr. 30, 2025

(30) Foreign Application Priority Data
Mar. 6, 2023 (CN) 202310205043.2

(51) Int. Cl. G06T 11/60

(52) U.S. Cl. CPC G06T 11/60; G06T 2200/24

(57) ABSTRACT

The disclosure relates to methods, apparatuses, devices, media, and program products for generating a panoramic video, and for playing a panoramic video. The method includes: acquiring an initial panoramic multimedia material; presenting a first material track fragment on a video editing interface, where a video editing track is presented on the video editing interface, the first material track fragment is presented on the video editing track, and the first material track fragment is formed based on the initial panoramic multimedia material; in response to an editing instruction of setting an interaction event for a first video track fragment in the video editing interface, presenting, in the video editing interface, a track fragment corresponding to the interaction event; and generating a target panoramic video based on the track fragment on the video editing track in the video editing interface.

This application claims priority of the Chinese Patent Application No. 202310205043.2, filed on Mar. 6, 2023, and entitled “METHOD, APPARATUS, DEVICE, MEDIUM, AND PROGRAM PRODUCT FOR GENERATING AND PLAYING PANORAMIC VIDEO” which is incorporated herein by reference in its entirety.

### FIELD

The present disclosure relates to the field of computer technologies, and in particular, to a method and an apparatus for generating a panoramic video, a method and an apparatus for playing a panoramic video, a device, a storage medium, and a program product.

### BACKGROUND

With the continuous development of multimedia technologies and internet technologies, a user may watch various videos on the internet with an intelligent terminal, and may further make a comment based on the effect of a watched video and the preference of the user for the video. If the user likes the video, the user may further like, repost, or perform other operations on the video.

However, although the user may comment on, like, repost, or perform other interaction operations on a video, the user cannot interact with a video being played, resulting in low interaction efficiency between the user and the video.

### SUMMARY

To solve the foregoing technical problems, embodiments of the present disclosure provide a method and apparatus for generating a panoramic video, a device, a storage medium, and a program product, such that the interaction efficiency between a user and a target video is improved.

In a first aspect, embodiments of the present disclosure provide a method for generating a panoramic video. The method includes:
acquiring an initial panoramic multimedia material;
presenting a first material track fragment on a video editing interface, wherein a video editing track is presented on the video editing interface, the first material track fragment is presented on the video editing track, and the first material track fragment is formed based on the initial panoramic multimedia material;
in response to an editing instruction of setting an interaction event for a first video track fragment in the video editing interface, presenting, in the video editing interface, a track fragment corresponding to the interaction event, wherein the editing instruction is configured to indicate an interaction material of the interaction event, a timeline position, and at least one branch material, the interaction material is configured to indicate at least one branch option operation of the interaction event, different branch option operations in the at least one branch option operation are configured to trigger presentation of different branch materials in the at least one branch material respectively, the track fragment corresponding to the interaction event includes a second material track fragment and at least one third material track fragment, the second material track fragment is disposed at the timeline position, the second material track fragment is formed based on the interaction material, and the at least one third material track fragment is formed based on the at least one branch material respectively; and
generating a target panoramic video based on the track fragment on the video editing track in the video editing interface.

In a second aspect, embodiments of the present disclosure provide a method for playing a panoramic video, wherein the panoramic video includes an initial panoramic multimedia material and an interaction event corresponding to the initial panoramic multimedia material. The method includes:
playing a panoramic video picture corresponding to a target panoramic video, wherein an interaction material of the interaction event, a timeline position, and at least one branch material are indicated, the interaction material is configured to indicate at least one branch option operation of the interaction event, different branch option operations in the at least one branch option operation are configured to trigger presentation of different branch materials in the at least one branch material respectively, a track fragment corresponding to the interaction event includes a second material track fragment and at least one third material track fragment, the second material track fragment is disposed at the timeline position, the second material track fragment is formed based on the interaction material, and the at least one third material track fragment is formed based on the at least one branch material respectively; and
in response to the target panoramic video being played to the timeline position, displaying, in the panoramic video picture, the interaction material included in the interaction event; and
in response to a trigger operation for the interaction material, presenting a video picture corresponding to a branch material that is associated with the interaction material and is included in the interaction event.

In a third aspect, embodiments of the present disclosure provide an apparatus for generating a panoramic video. The apparatus includes:
a panoramic multimedia material acquiring module, configured to acquire an initial panoramic multimedia material;
a video editing interface display module, configured to present a first material track fragment on a video editing interface, wherein a video editing track is presented on the video editing interface, the first material track fragment is presented on the video editing track, and the first material track fragment is formed based on the initial panoramic multimedia material;
an interaction event editing module, configured to in response to an editing instruction of setting an interaction event for a first video track fragment in the video editing interface, present, in the video editing interface, a track fragment corresponding to the interaction event, wherein the editing instruction is configured to indicate an interaction material of the interaction event, a timeline position, and at least one branch material, the interaction material is configured to indicate at least one branch option operation of the interaction event, different branch option operations in the at least one branch option operation are configured to trigger presentation of different branch materials in the at least one branch material respectively, the track fragment corresponding to the interaction event includes a second material track fragment and at least one third material track fragment, the second material track fragment is disposed at the timeline position, the second material track fragment is formed based on the interaction material, and the at least one third material track fragment is formed based on the at least one branch material respectively; and
a target panoramic video generating module, configured to generate a target panoramic video based on the track fragment on the video editing track in the video editing interface.

In a third aspect, embodiments of the present disclosure provide an apparatus for playing a panoramic video, wherein the panoramic video includes an initial panoramic multimedia material and an interaction event corresponding to the initial panoramic multimedia material. The apparatus includes:
a panoramic video picture play module, configured to play a panoramic video picture corresponding to a target panoramic video, wherein an interaction material of the interaction event, a timeline position, and at least one branch material are indicated, the interaction material is configured to indicate at least one branch option operation of the interaction event, different branch option operations in the at least one branch option operation are configured to trigger presentation of different branch materials in the at least one branch material respectively, a track fragment corresponding to the interaction event includes a second material track fragment and at least one third material track fragment, the second material track fragment is disposed at the timeline position, the second material track fragment is formed based on the interaction material, and the at least one third material track fragment is formed based on the at least one branch material respectively;
an interaction material display module, configured to in response to the target panoramic video being played to the timeline position, display, in the panoramic video picture, the interaction material included in the interaction even; and
a branch material picture display module, configured to in response to a trigger operation for the interaction material, present a video picture corresponding to a branch material that is associated with the interaction material and is included in the interaction event.

In a fifth aspect, embodiments of the present disclosure provide an electronic device. The electronic device includes:
one or more processors; and
a storage apparatus configured to store one or more programs, wherein
the one or more programs, when being executed by the one or more processors, enable the one or more processors to implement the method for generating the panoramic video according to any item of the foregoing first aspect or the method for playing the panoramic video according to any item of the foregoing second aspect.

In a sixth aspect, embodiments of the present disclosure provide a computer-readable storage medium, storing a computer program therein, wherein the program, when being executed by a processor, implements the method for generating the panoramic video according to any item of the foregoing first aspect or the method for playing the panoramic video according to any item of the foregoing second aspect.

In a seventh aspect, embodiments of the present disclosure provide a computer program product, including a computer a program or instruction, wherein the computer program or instruction, when being executed by a processor, implements the method for generating the panoramic video according to any item of the foregoing first aspect or the method for playing the panoramic video according to any item of the foregoing second aspect.

The embodiments of the present disclosure provide a method and apparatus for generating a panoramic video, a device, a storage medium, and a program product. The method includes: acquiring an initial panoramic multimedia material; presenting a first material track fragment on a video editing interface, wherein a video editing track is presented on the video editing interface, the first material track fragment is presented on the video editing track, and the first material track fragment is formed based on the initial panoramic multimedia material; in response to an editing instruction of setting an interaction event for a first video track fragment in the video editing interface, presenting, in the video editing interface, a track fragment corresponding to the interaction event, wherein the editing instruction is configured to indicate an interaction material of the interaction event, a timeline position, and at least one branch material, the interaction material is configured to indicate at least one branch option operation of the interaction event, different branch option operations in the at least one branch option operation are configured to trigger presentation of different branch materials in the at least one branch material respectively, the track fragment corresponding to the interaction event includes a second material track fragment and at least one third material track fragment, the second material track fragment is disposed at the timeline position, the second material track fragment is formed based on the interaction material, and the at least one third material track fragment is formed based on the at least one branch material respectively; and generating a target panoramic video based on the track fragment on the video editing track in the video editing interface. In the embodiments of the present disclosure, by means of presenting in the video editing interface the track fragment corresponding to the interaction event, after a branch operation option in the interaction event is triggered, a branch material corresponding to the branch operation option is displayed, such that the interaction efficiency between a user and a target video is improved.

### BRIEF DESCRIPTION OF THE DRAWINGS

The foregoing and other features, advantages, and aspects of embodiments of the present disclosure will become more apparent in conjunction with the accompanying drawings and with reference to the following specific embodiments. Throughout the accompanying drawings, the same or similar numerals indicate the same or similar elements. It should be understood that the accompanying drawings are schematic and that the parts and elements are not necessarily drawn to scale.

FIG. 1 illustrates an architectural diagram of a video making scenario provided by embodiments of the present disclosure;

FIG. 2 is a schematic flowchart of a method for generating a panoramic video according to an embodiment of the present disclosure;

FIG. 3 is a schematic diagram of a panoramic video editing interface according to an embodiment of the present disclosure;

FIG. 4 is a schematic flowchart of a method for playing a panoramic video according to an embodiment of the present disclosure;

FIG. 5 is a schematic diagram of a panoramic video playing interface according to an embodiment of the present disclosure;

FIG. 6 is a schematic structural diagram of an apparatus for generating a panoramic video according to an embodiment of the present disclosure;

FIG. 7 is a schematic structural diagram of an apparatus for playing a panoramic video according to an embodiment of the present disclosure; and

FIG. 8 is a schematic structural diagram of an electronic device according to an embodiment of the present disclosure.

### DETAILED DESCRIPTION

The following describes embodiments of the present disclosure in more detail with reference to the accompanying drawings. Although some embodiments of the present disclosure are shown in the accompanying drawings, it should be understood that the present disclosure may be implemented in various forms, and should not be construed as being limited to the embodiments described herein. On the contrary, these embodiments are provided for more thorough and complete understanding of the present disclosure. It should be understood that the accompanying drawings and embodiments of the present disclosure are merely used as examples, but are not intended to limit the protection scope of the present disclosure.

It should be understood that the individual steps described in the method embodiments of the present disclosure may be performed in different orders, and/or in parallel. In addition, the method embodiments may include additional steps and/or omit the steps illustrated. The scope of the present disclosure is not limited in this regard.

The term “include” and its variations used herein are an open inclusion, that is, “including, but not limited to.” The term “based on” means “based, at least in part, on.” The term “an embodiment” means “at least one embodiment.” The term “another embodiment” means “at least one additional embodiment.” The term “some embodiments” means “at least some embodiments.” Relevant definitions of other terms will be given in the descriptions below.

It should be noted that the concepts such as “first” and “second” mentioned in the present disclosure are used only to distinguish between different apparatuses, modules or units, and are not intended to define the order or mutual interdependence of the functions performed by these apparatuses, modules or units.

It should be noted that the modifications of “one” and “more than one” referred to in the present disclosure are illustrative rather than limiting, and it should be understood by those skilled in the art to mean “one or more” unless the context clearly indicates otherwise.

The names of messages or information exchanged among the plurality of apparatuses in the embodiments of the present disclosure are used for illustrative purposes only and are not intended to limit the scope of these messages or information.

The expression“ in response to” is configured to indicate a condition or state on which an operation to be performed depends. When the condition or state on which the operation depends is met, one or more operations to be performed may be real-time or may have set delays. Unless specially indicated, an execution sequence of the plurality of operations to be performed is not limited.

FIG. 1 is a schematic diagram of a scenario that can be used to implement an information delivery method provided in embodiments of the present disclosure. As shown in FIG. 1, a system 100 may include a plurality of user terminals 110, a network 120, a server 130, and a database 140. For example, the system 100 may be used to implement the information delivery method in any embodiment of the present disclosure.

It may be understood that, the user terminals 110 may be electronic devices of any other types that can perform data processing, and may include, but are not limited to, a mobile phone, a station, a unit, a device, a multimedia computer, a multimedia tablet, an internet node, a communication device, a desktop computer, a laptop computer, a notebook computer, a netbook computer, a tablet computer (PAD), a personal communication system (PCS) device, a personal navigation device, a personal digital assistant (PDA), an audio/video player, a digital camera/video recorder, a positioning device, a television (TV) receiver, a radio broadcast receiver, an electronic book device, a gaming device or any combination thereof, and include accessories and peripherals of these devices or any combination thereof.

A user may perform operations through an application installed on each of the user terminals 110. The application transmits behavior data of the user to the server 130 through the network 120. The user terminal 110 may further receive, through the network 120, the data transmitted by the server 130. A hardware system and a software system of the user terminal 110 are not limited in the embodiments of the present disclosure. For example, the user terminal 110 may be based on an ARM processor, an X86 processor, or another processor, may be provided with input/output devices such as a camera, a touchscreen, and a microphone, and may run Windows, iOS, Linux, Android, HarmonyOS, or another operating system.

The user terminal 110 may implement the information delivery method provided in the embodiments of the present disclosure by running processes or threads. In some examples, the user terminal 110 may perform the information delivery method by using an application embedded therein. In some other examples, the user terminal 110 may perform the information delivery method by calling an application stored outside the user terminal 110.

The network 120 may be a single network, or a combination of at least two different networks. For example, the network 120 may include, but are not limited to, one or a combination of a plurality of a local area network, a wide area network, a public network, a private network, and the like. The network 120 may be one of computer networks such as the internet and/or various telecommunications networks (e.g., a 3G/4G/5G mobile communication network, Wi-Fi, Bluetooth, or ZigBee). This is not limited in the embodiments of the present disclosure.

The server 130 may be a separate server, or a server group, or a cloud server. Servers in the server group are connected by a wired or wireless network. One server group may be centralized, for example, a data center, or may be distributed. The server 130 may be local or remote. The server 130 may communicate with the user terminal 110 through a wired or wireless network. A hardware system and a software system of the server 130 are not limited in the embodiments of the present disclosure.

The database 140 may generally refer to a device having a storage function. The database 140 is mainly configured to store various data used, generated, and outputted by the user terminal 110 and the server 130 during operation. The database 140 may be local or remote. The database 140 may include various memories, for example, a random access memory (RAM), or a read-only memory (ROM). The storage devices mentioned above are merely some examples, and storage devices that can be used in the system 100 are not limited thereto. A hardware system and a software system of the database 140 are not limited in the embodiments of the present disclosure. For example, the database may be a relational database or a non-relational database.

The database 140 may be connected to or communicate with the server 130 or a part thereof through the network 120, or may be directly connected to or communicate with the server 130, or a combination of the foregoing two fashions is used.

In some examples, the database 140 may be an independent device. In some other examples, the database 140 may be integrated in at least one of the user terminal 110 and the server 130. For example, the database 140 may be disposed on the user terminal 110 or may be disposed on the server 130. For another example, the database 140 may be distributed, with one part thereof being disposed on the user terminal 110 and another part being disposed on the server 130.

A method for generating a panoramic video provided in embodiments of this application is described below in detail with reference to the accompanying drawings.

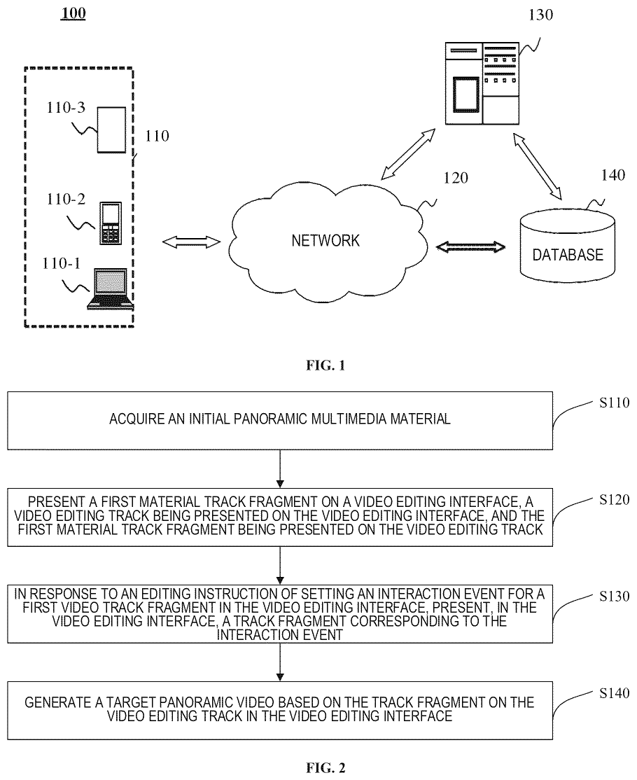

FIG. 2 is a flowchart of a method for generating a panoramic video according to an embodiment of the present disclosure. This embodiment is applicable to a case of generating a panoramic interaction video. The method may be performed by an apparatus for generating a panoramic video. The apparatus for generating the panoramic video may be implemented in a software and/or hardware fashion. The method for generating the panoramic video may be performed by the electronic device in FIG. 1.

As shown in FIG. 2, the method for generating the panoramic video provided in this embodiment of the present disclosure mainly includes step S110 to step S140.

At block S110, an initial panoramic multimedia material is acquired.

In this embodiment of the present disclosure, the initial panoramic multimedia material may be understood as a multimedia material included in an initial panoramic video. For example, the initial panoramic multimedia material may include one or a combination of a plurality of a video material, an audio material, an image material (a sticker, a picture in picture, or a special effect), and the like. In this embodiment of the present disclosure, the description is provided by using an example that the initial panoramic multimedia material is a panoramic video material.

In an implementation of the present disclosure, the initial panoramic multimedia material may be a panoramic video shot by a panoramic video creator, or may be a virtual panoramic video created by a panoramic video creator through a video creation platform. In this embodiment of the present disclosure, a fashion of making the initial panoramic multimedia material is not limited.

At block S120, a first material track fragment is presented on a video editing interface, wherein a video editing track is presented on the video editing interface, the first material track fragment is presented on the video editing track, and the first material track fragment is formed based on the initial panoramic multimedia material.

In an implementation of the present disclosure, the acquired initial panoramic multimedia material is introduced into a video editor, so that a video editing interface of the video editor may present the first material track fragment corresponding to the initial panoramic multimedia material.

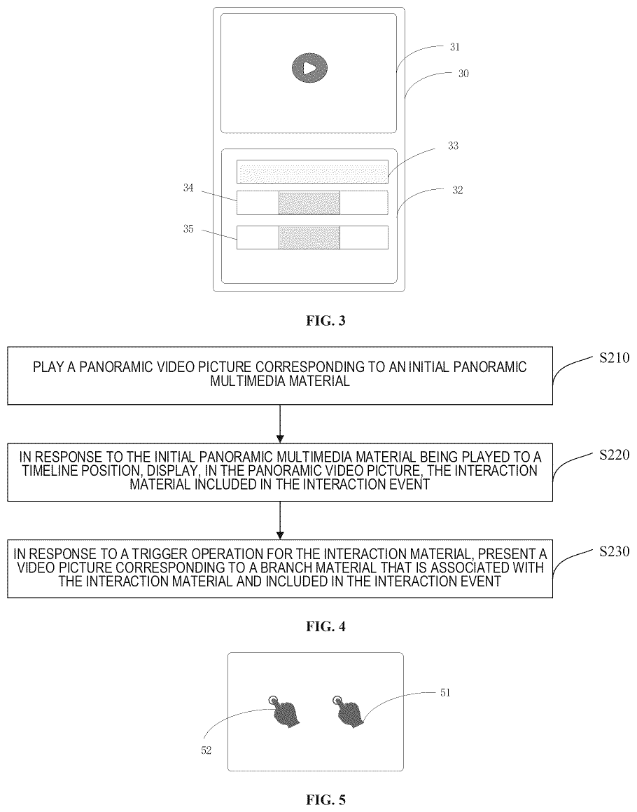

In an implementation of the present disclosure, as shown in FIG. 3, the video editing interface 30 includes a video picture presentation area 31 and a video track fragment presentation area 32. The video picture presentation area 31 is configured to present a panoramic video picture corresponding to the initial panoramic multimedia material. The video track fragment presentation area 32 includes the first material track fragment 33. The panoramic video picture presented in the video picture presentation area 31 corresponds to a timeline of the first material track fragment 33. That is, when a user clicks on the third second in the first material track fragment 33, a video picture corresponding to a panoramic multimedia material at the third second is presented in the video picture presentation area 31.

At block S130, in response to an editing instruction of setting an interaction event for a first video track fragment in the video editing interface, a track fragment corresponding to the interaction event is presented in the video editing interface, where the editing instruction is configured to indicate an interaction material of the interaction event, a timeline position, and at least one branch material, the interaction material is configured to indicate at least one branch option operation of the interaction event, different branch option operations in the at least one branch option operation are configured to trigger presentation of different branch materials in the at least one branch material respectively, the track fragment corresponding to the interaction event includes a second material track fragment and at least one third material track fragment, the second material track fragment is disposed at the timeline position, the second material track fragment is formed based on the interaction material, and the at least one third material track fragment is formed based on the at least one branch material respectively.

In this embodiment of the present disclosure, track fragments corresponding to a plurality of interaction events may be added to the video editing interface. As shown in FIG. 3, track fragments corresponding to two interaction events may be added to the video editing interface. Each interaction event corresponds to one track fragment. This embodiment of the present disclosure is described with an example that two interaction events are added. That is, as shown in FIG. 3, a second material track fragment 34 and a second material track fragment 35 are included. In the second material track fragment 34 and the second material track fragment 35, gray parts represent that at timeline positions of the second material track fragments, interaction materials corresponding thereto are displayed, and white parts represent that the second material track fragment 34 and the second material track fragment 35 are blank fragments.

In this embodiment of the present disclosure, when the interaction event is a voice interaction event, the interaction material is configured to indicate voice information that needs to be inputted by a user.

The description is given with an example that the gray part of the second material track fragment 34 is a material track fragment corresponding to the interaction material. When the panoramic video corresponding to the initial panoramic multimedia material is played to a timeline start position, the interaction material is displayed in the panoramic video picture. The interaction material is configured to prompt voice information that needs to be inputted by the user. When the panoramic video corresponding to the initial panoramic multimedia material is played to a timeline end position, the interaction material disappears in the panoramic video picture, and the interaction material is no longer displayed.

In this embodiment of the present disclosure, when the interaction event is a touch interaction event, the interaction material is configured to indicate an area that needs to be touched by a user.

The description is given with an example that the gray part of the second material track fragment 34 is a material track fragment corresponding to the interaction material and the gray part of the second material track fragment 35 is a material track fragment corresponding to the interaction material. As shown in FIG. 3, in this editing process, an editing instruction of an interaction event is configured. That is, two second material track fragments exist. In addition, timeline positions corresponding to the two second material track fragments are the same. When the panoramic video corresponding to the initial panoramic multimedia material is played to a timeline start position, two interaction materials are displayed in the panoramic video picture. The two interaction materials are configured to prompt two areas that need to be touched by user. The user may select one of the two interaction materials for triggering, so that the panoramic video may jump to a branch material associated with a touched interaction material for playing. When the panoramic video corresponding to the initial panoramic multimedia material is played to a timeline end position, the interaction material disappears in the panoramic video picture, the interaction material is no longer displayed, and it will also not jump to a panoramic video corresponding to the branch material.

In this embodiment of the present disclosure, the video creator may freely set a touchable area indicated by the interaction material.

It needs to be noted that a touch is used as an example for description in this embodiment of the present disclosure. A setting fashion of a press interaction event is the same as a setting fashion of the touch interaction event and thus is not described in this embodiment of the present disclosure.

When the interaction event is a gesture tracking interaction event, the interaction material is configured to indicate an action gesture that needs to be performed by a user. When the interaction event is the gesture tracking interaction event, the interaction material may be position information in 6-degree of freedom or 3-degree of freedom. Further, the interaction event is the gesture tracking interaction event, a rotation angle and a movement distance on each axis. A specific setting fashion thereof is the same as a setting fashion of the foregoing interaction event and thus is not described again in this embodiment of the present disclosure.

In an implementation of the present disclosure, presenting, in response to the editing instruction of setting the interaction event for the first video track fragment in the video editing interface, in the video editing interface the track fragment corresponding to the interaction event includes: in response to triggering of an interactive event addition instruction for the first video track fragment in the video editing interface, adding, in the in the video editing interface, the second material track fragment corresponding to the interaction material in the interaction event; and in response to a time selection operation for the second material track fragment in the video editing interface, acquiring a timeline position corresponding to the time selection operation as the timeline position corresponding to the second material track fragment.

In this embodiment of the present disclosure, a control for adding an interaction event is displayed in the video editing interface. In response to the control for adding an interaction event, interaction materials (a voice interaction event, a touch interaction event, a press interaction event, and a gesture tracking interaction event) that can be added may be acquired and displayed. In response to a selection operation for the interaction material, the second material track fragment corresponding to the interaction material is added to the video editing interface.

Further, in response to a time selection operation for the second material track fragment by the video creator, a timeline position corresponding to a selected interaction material is determined.

In an implementation of the present disclosure, presenting, in response to the editing instruction of setting the interaction event for the first video track fragment in the video editing interface, in the video editing interface the track fragment corresponding to the interaction event includes: acquiring, in response to a branch material selection operation for the second material track fragment in the video editing interface, a branch material corresponding to the branch material selection operation, and creating a third material track fragment corresponding to the branch material; and establishing an association relationship between the branch material and the interaction material, so that the branch option operation indicated by the interaction material is configured to trigger presentation of the branch material corresponding to the third material track fragment.

In an implementation of the present disclosure, the interaction material is configured to indicate at least one branch option operation of the interaction event, different branch option operations in the at least one branch option operation are configured to trigger presentation of different branch materials in the at least one branch material respectively, the track fragment corresponding to the interaction event includes at least one third material track fragment, and the at least one third material track fragment is formed based on the at least one branch material respectively.

In an implementation of the present disclosure, an editing operation of an interaction event similar to that of the first video track fragment may further be performed on the third material track fragment formed by the branch material.

At block 140, a target panoramic video is generated based on the track fragment on the video editing track in the video editing interface.

In an implementation of the present disclosure, generating the target panoramic video based on the track fragment on the video editing track in the video editing interface includes: in response to triggering of a generating operation for the target panoramic video in the video editing interface, generating the target interaction video based on the track fragment on the video editing track in the video editing interface.

In this embodiment of the present disclosure, the video editing interface includes a video generation control, and in response to a trigger operation for the video generation control, the target interaction video is generated based on the track fragment on the video editing track in the video editing interface. Further, the target panoramic video may be stored locally for private consumption, or the target panoramic video may be posted on a video platform for consumption by other users.

FIG. 4 is a flowchart of a method for playing a panoramic video according to an embodiment of the present disclosure. This embodiment is applicable to a case of consuming a panoramic interaction video. The method may be performed by an apparatus for playing a panoramic video. The apparatus for generating a panoramic video may be implemented in a software and/or hardware fashion. The method for playing the panoramic video may be performed by the electronic device in FIG. 1. The electronic device may be any one or more of an AR device, a VR device, or an XR device.

As shown in FIG. 4, the method for playing the panoramic video provided in this embodiment of the present disclosure mainly includes step S210 to step S230.

At block S210, a panoramic video picture corresponding to a target panoramic video is played, wherein an interaction material of an interaction event, a timeline position, and at least one branch material are indicated, the interaction material is configured to indicate at least one branch option operation of the interaction event, different branch option operations in the at least one branch option operation are configured to trigger presentation of different branch materials in the at least one branch material respectively, a track fragment corresponding to the interaction event includes a second material track fragment and at least one third material track fragment, the second material track fragment is disposed at the timeline position, the second material track fragment is formed based on the interaction material, and the at least one third material track fragment is formed based on the at least one branch material respectively.

In this embodiment of the present disclosure, the target panoramic video is a target panoramic video that is acquired by using the method for generating the panoramic video in the foregoing embodiment. Further, the target panoramic video may be a target panoramic video acquired locally, or may be a panoramic video downloaded from a video platform. A fashion of acquiring the panoramic video is no longer specifically limited in this embodiment of the present disclosure.

In this embodiment of the present disclosure, before playing the panoramic video picture corresponding to the target panoramic video, the method further includes: acquiring a description file, and parsing the description file to acquire an initial panoramic multimedia material and the interaction event corresponding to the initial panoramic multimedia material.

In this embodiment of the present disclosure, after acquiring the description file and parsing the description file, a video consumption user acquires the initial panoramic multimedia material and the interaction event corresponding to the initial panoramic multimedia material.

At block S220, in response to the target panoramic video being played to the timeline position, the interaction material included in the interaction event is displayed in the panoramic video picture.

In this embodiment of the present disclosure, the foregoing panoramic video is played in response to a playing operation for the panoramic video by the video consumption user. When the panoramic video is played to the timeline position, the interaction material included in the interaction event is displayed in the panoramic video picture. The interaction material is configured to indicate at least one branch option operation of the interaction event, and different branch option operations in the at least one branch option operation are configured to trigger presentation of different branch materials in the at least one branch material respectively.

In this embodiment of the present disclosure, the description is given with an example that the interaction event is a voice interaction event. In response to the panoramic video being played to a timeline start position corresponding to the interaction material, the interaction material is displayed in a superimposed fashion on the video picture. The interaction material is configured to indicate at least one branch option operation of the interaction event. For example, the interaction material may be voice information that needs to be inputted by the user prompted in the form of a text box, or the interaction material may be voice information that needs to be inputted by the user prompted in the form of voice playing. Alternatively, the interaction material may be presented in a special effect fashion or a picture in picture fashion. Further, one or more interaction materials may be provided. A quantity of interaction materials is no longer specifically limited in this embodiment of the present disclosure.

At block S230, in response to a trigger operation for the interaction material, a video picture corresponding to a branch material that is associated with the interaction material and is included in the interaction event is presented.

In this embodiment of the present disclosure, when the interaction event is a voice interaction event, in response to the trigger operation for the interaction material includes: extracting semantic feature information from acquired voice information; calculating a matching degree between the semantic feature information of the voice information and the preset semantic feature information based on the semantic feature information of the voice information and the preset semantic feature information corresponding to the interaction material; and receiving, based on the matching degree being greater than a matching degree threshold, the trigger operation for the interaction material.

In this embodiment of the present disclosure, after inputting voice information according to an indication of the interaction material, the video consumption user extracts semantic feature information from the acquired voice information; calculates the matching degree between the semantic feature information of the voice information and the preset semantic feature information based on the semantic feature information of the voice information and the preset semantic feature information corresponding to the interaction material; and receives, based on the matching degree being greater than the matching degree threshold, the trigger operation for the interaction material.

For example, two interaction materials correspond to different preset semantic feature information respectively. Preset semantic feature information corresponding to an interaction material 1 is moving forward by one step, and preset semantic feature information corresponding to an interaction material is moving backward by one step. If a matching degree between the semantic feature information extracted from the acquired voice information and the preset semantic feature information corresponding to the interaction material 1 is greater than the matching degree threshold, a panoramic video picture corresponding to a branch material associated with the interaction material 1 is played. If a matching degree between the semantic feature information extracted from the acquired voice information and the preset semantic feature information corresponding to the interaction material 2 is greater than the matching degree threshold, a panoramic video picture corresponding to a branch material associated with the interaction material 2 is played.

In an implementation of the present disclosure, when the interaction event is a gesture tracking interaction event, presenting, in response to the trigger operation for the interaction material, the video picture corresponding to the branch material that is included in the interaction event and is associated with the interaction material includes: recognizing an action gesture performed by a user; and when a recognized current action gesture is a preset action gesture, presenting a panoramic video picture associated with an interaction control corresponding to the preset action gesture.

In this embodiment of the present disclosure, after the video consumption user makes a specified action gesture according to an indication of the interaction material, an action gesture performed by the user is recognized; and when the recognized current action gesture is the preset action gesture, the panoramic video picture associated with the interaction control corresponding to the preset action gesture is presented.

For example, the interaction material indicates the user to perform a wave action. If the wave action performed by the user is recognized, a panoramic video corresponding to a branch material corresponding to the wave action is played.

In an implementation of the present disclosure, when the interaction event is a touch interaction event, presenting, in response to an operation for an interaction control, a panoramic video picture associated with the interaction control includes: receiving, in response to a touch operation for an area that needs to be touched by a user indicated by the interaction material, the trigger operation for the interaction material.

In this embodiment of the present disclosure, after triggering the area that needs to be touched according to the indication of the interaction material, the video consumption user determines a branch material associated with the touch area, and plays a panoramic video corresponding to the branch material.

As shown in FIG. 5, the interaction material is presented as two hand marks to indicate that the video consumption user can perform a touch or press operation on the area. For example, the two hand marks correspond to different branch materials respectively. If a left hand mark is touched, the panoramic video picture corresponding to the branch material associated with the interaction material 1 is played. If a right hand mark is touched, the panoramic video picture corresponding to the branch material associated with the interaction material 2 is played.

In this embodiment of the present disclosure, if the video consumption user performs no interaction operation within a time range in which the interaction material is presented, a panoramic video corresponding to any branch material is not played, and only the panoramic video corresponding to the initial panoramic multimedia material is played.

In this embodiment of the present disclosure, in a process of playing the target panoramic video, in response to the trigger operation for the interaction material by the user, a jump is made to a branch video corresponding to the trigger operation, thereby improving the interactivity between the user and the video.

The apparatus for generating the panoramic video provided in this embodiment of the present disclosure can perform the steps performed in the method for generating the panoramic video provided in this embodiment of the present disclosure, and details of the performed steps and beneficial effects are not described herein again.

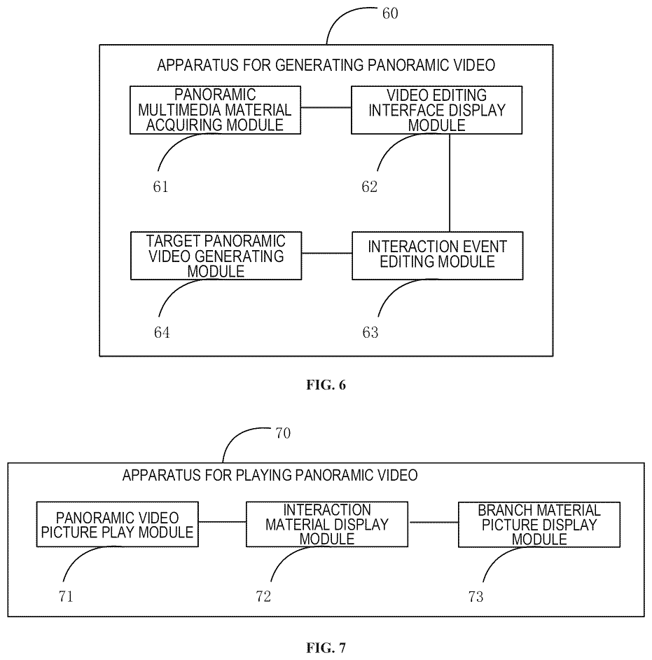

FIG. 6 is a schematic structural diagram of an apparatus for generating a panoramic video according to an embodiment of the present disclosure. This embodiment is applicable to a case of generating a panoramic interaction video. The method may be performed by an apparatus for generating a panoramic video. The apparatus for generating the panoramic video may be implemented in a software and/or hardware fashion. The method for generating the panoramic video may be performed by the electronic device in FIG. 1.

As shown in FIG. 6, an apparatus 60 for generating a panoramic video provided in this embodiment of the present disclosure mainly includes a panoramic multimedia material acquiring module 61, a video editing interface display module 62, an interaction event editing module 63, and a target panoramic video generating module 64.

The panoramic multimedia material acquiring module 61 is configured to acquire an initial panoramic multimedia material. The video editing interface display module 62 is configured to present a first material track fragment on a video editing interface, wherein a video editing track is presented on the video editing interface, the first material track fragment is presented on the video editing track, and the first material track fragment is formed based on the initial panoramic multimedia material. The interaction event editing module 63 is configured to in response to an editing instruction of setting an interaction event for a first video track fragment in the video editing interface, present, in the video editing interface, a track fragment corresponding to the interaction event, wherein the editing instruction is configured to indicate an interaction material of the interaction event, a timeline position, and at least one branch material, the interaction material is configured to indicate at least one branch option operation of the interaction event, different branch option operations in the at least one branch option operation are configured to trigger presentation of different branch materials in the at least one branch material respectively, the track fragment corresponding to the interaction event includes a second material track fragment and at least one third material track fragment, the second material track fragment is disposed at the timeline position, the second material track fragment is formed based on the interaction material, and the at least one third material track fragment is formed based on the at least one branch material respectively. The target panoramic video generating module 64 is configured to generate a target panoramic video based on the track fragment on the video editing track in the video editing interface.

In an implementation of the present disclosure, the interaction event editing module 63 is specifically configured to: in response to triggering of an interactive event addition instruction for the first video track fragment in the video editing interface, add, in the video editing interface, the second material track fragment corresponding to the interaction material in the interaction event; and in response to a time selection operation for the second material track fragment in the video editing interface, acquire a timeline position corresponding to the time selection operation as the timeline position corresponding to the second material track fragment.

In an implementation of the present disclosure, the interaction event editing module 63 is specifically configured to: acquire, in response to a branch material selection operation for the second material track fragment in the video editing interface, a branch material corresponding to the branch material selection operation, and create a third material track fragment corresponding to the branch material; and establish an association relationship between the branch material and the interaction material, so that the branch option operation indicated by the interaction material is configured to trigger presentation of the branch material corresponding to the third material track fragment.

In an implementation of the present disclosure, when the interaction event is a voice interaction event, the interaction material is configured to indicate voice information that needs to be inputted by a user.

In an implementation of the present disclosure, when the interaction event is a touch interaction event, the interaction material is configured to indicate an area that needs to be touched by a user.

In an implementation of the present disclosure, when the interaction event is a gesture tracking interaction event, the interaction material is configured to indicate an action gesture that needs to be performed by a user.

In an implementation of the present disclosure, the target panoramic video generating module 64 is specifically configured to generate, in response to triggering of a generating operation for the target panoramic video in the video editing interface, generate the target panoramic video based on the track fragment on the video editing track in the video editing interface.

The apparatus for generating the panoramic video provided in this embodiment of the present disclosure can perform the steps performed in the method for generating the panoramic video provided in this embodiment of the present disclosure, and details of the performed steps and beneficial effects are not described herein again.

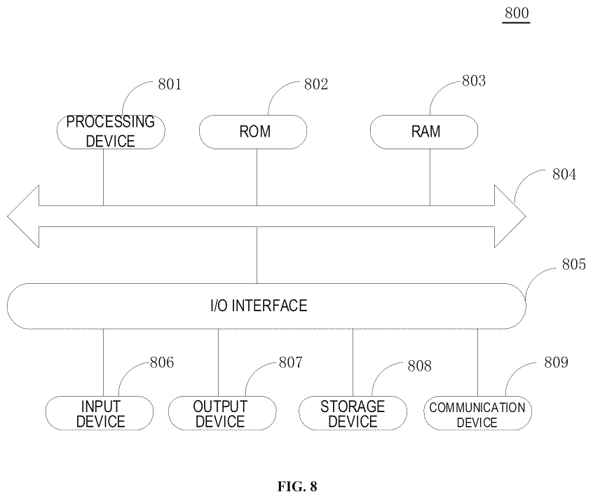

FIG. 7 is a schematic structural diagram of an apparatus for playing a panoramic video according to an embodiment of the present disclosure. This embodiment is applicable to a case of consuming a panoramic interaction video. The method may be performed by an apparatus for playing a panoramic video. The apparatus for generating the panoramic video may be implemented in a software and/or hardware fashion. The method for playing the panoramic video may be performed by the electronic device in FIG. 1. The electronic device may be any one or more of an AR device, a VR device, or an XR device.

As shown in FIG. 7, the apparatus for playing the panoramic video provided in this embodiment of the present disclosure mainly includes a panoramic video picture play module 71, an interaction material display module 72, and a branch material picture display module 73.

The panoramic video picture play module 71 is configured to play a panoramic video picture corresponding to a target panoramic video, wherein an interaction material of an interaction event, a timeline position, and at least one branch material are indicated, the interaction material is configured to indicate at least one branch option operation of the interaction event, different branch option operations in the at least one branch option operation are configured to trigger presentation of different branch materials in the at least one branch material respectively, a track fragment corresponding to the interaction event includes a second material track fragment and at least one third material track fragment, the second material track fragment is disposed at the timeline position, the second material track fragment is formed based on the interaction material, and the at least one third material track fragment is formed based on the at least one branch material respectively. The interaction material display module 72 is configured to in response to the target panoramic video being played to the timeline position, display, in the panoramic video picture, the interaction material included in the interaction even. The branch material picture display module 73 is configured to in response to a trigger operation for the interaction material, present a video picture corresponding to a branch material that is associated with the interaction material and is included in the interaction event.

In an implementation of the present disclosure, the apparatus further includes: a description file parsing module configured to: before the panoramic video picture corresponding to the target panoramic video is played, acquire a description file, and parse the description file to acquire an initial panoramic multimedia material and the interaction event corresponding to the initial panoramic multimedia material.

In an implementation of the present disclosure, when the interaction event is a voice interaction event, in response to the trigger operation for the interaction material includes: extracting semantic feature information from acquired voice information; calculating a matching degree between the semantic feature information of the voice information and the preset semantic feature information based on the semantic feature information of the voice information and preset semantic feature information corresponding to the interaction material; and receiving, based on the matching degree being greater than a matching degree threshold, the trigger operation for the interaction material.

In an implementation of the present disclosure, when the interaction event is a gesture tracking interaction event, in response to the trigger operation for the interaction material includes: recognizing an action gesture performed by a user; and when a recognized current action gesture is a preset action gesture, presenting a panoramic video picture associated with an interaction control corresponding to the preset action gesture.

In an implementation of the present disclosure, when the interaction event is a touch interaction event, in response to an operation for an interaction control includes: receiving, in response to a touch operation for an area that needs to be touched by a user indicated by the interaction material, the trigger operation for the interaction material.

The apparatus for playing the panoramic video provided in this embodiment of the present disclosure can perform the steps performed in the method for playing the panoramic video provided in this embodiment of the present disclosure, and details of the performed steps and beneficial effects are not described herein again.

FIG. 8 is a schematic structural diagram of an electronic device according to an embodiment of the present disclosure. Refer to FIG. 8 for details below. FIG. 8 is a schematic structural diagram of an electronic device 800 suitable for implementing embodiments of the present disclosure. The electronic device 800 in this embodiment of the present disclosure may include, but is not limited to, a mobile terminal, such as a mobile phone, a notebook computer, a digital broadcast receiver, a PDA, a PAD, a portable media player (PMP), a vehicle-mounted terminal (e.g., vehicle-mounted navigation terminal), and a wearable terminal device, and a fixed terminal such as a digital TV, a desktop computer, and a smart home device. The electronic device shown in FIG. 8 is only an example, but should not constitute any limitation to the functions and use scope of the embodiments of the present disclosure.

As shown in FIG. 8, the electronic device 800 may include a processing device (e.g., a central processing unit, or a graphics processing unit) 801 that may perform various appropriate actions and processing according to a program stored in a read-only memory (ROM) 802 or a program loaded from a storage device 808 into a random access memory (RAM) 803 to implement a picture rendering method in this embodiment of the present disclosure. The RAM 803 may further store various programs and data required for the operation of the terminal device 800. The processing device 801, the ROM 802, and the RAM 803 are connected to each other by a bus 804. An input/output (I/O) interface 805 is also connected to the bus 804.

Generally, the following devices may be connected to the I/O interface 805: input device 806 including, for example, a touchscreen, a touchpad, a keyboard, a mouse, a camera, a microphone, an accelerometer, and a gyroscope; output device 807 including, for example, a liquid crystal display (LCD), a loudspeaker and a vibrator; storage device 808 including, for example, a magnetic tape and a hard disk; and a communication device 809. The communication device 809 may allow the terminal device 800 to communicate wirelessly or wired with another device to exchange data. Although FIG. 8 shows the terminal device 800 with various devices, it should be understood that it is not required to implement or provide all shown devices. Alternatively, more or fewer device may be implemented or provided.

Especially, according to the embodiments of the present disclosure, the process described with reference to the flowchart above may be implemented as a computer software program. For example, the embodiments of the present disclosure include a computer program product, including a computer program carried in a non-transitory computer-readable medium. The computer program contains a program code for performing the method as shown in the flowchart, to implement the method for generating the panoramic video described above. In such an embodiment, the computer program may be downloaded and installed from the network via the communication device 809, or installed from the storage device 808, or installed from the ROM 802. When the computer program is executed by the processing device 801, the foregoing functions defined in the method in the embodiments of the present disclosure are performed.

It should be noted that the foregoing computer-readable medium in the present disclosure may be a computer-readable signal medium, a computer-readable storage medium or any combination thereof. The computer-readable storage medium may be, for example, but is not limited to, an electronic, magnetic, optical, electromagnetic, infrared, or semiconductor system, apparatus or device, or any combination thereof. More specific examples of the computer-readable storage medium may include, but are not limited to: an electrical connection having one or more wires, a portable computer disc, a hard disk, an RAM, an ROM, an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program. The program may be used by or in combination with an instruction execution system, apparatus or device. In the present disclosure, the computer-readable signal medium may include a data signal with a computer-readable program code carried therein, propagated in a baseband or as part of a carrier. Such a propagated data signal may take any of a variety of forms, including, but not limited to, an electromagnetic signal, an optical signal, or any suitable combination thereof. The computer-readable signal medium may be any computer-readable medium except a computer-readable storage medium and can send, propagate, or transmit a program for use by or in combination with an instruction execution system, apparatus or device. The program code contained in the computer-readable medium may be transmitted using any appropriate medium, including but not limited to a wireline, an optical cable, a radio frequency (RF), etc., or any suitable combination thereof.

In some implementations, the client and the server may communicate by using any currently known or future developed network protocol such as the HyperText Transfer Protocol (HTTP) and may interconnect with any form or medium of digital data communication (e.g., a communication network). Examples of the communication network include a local area network (LAN), a wide area network (WAN), a network of networks (e.g., an internet), and an end-to-end network (an ad hoc end-to-end network), as well as any currently known or future developed network.

The foregoing computer-readable medium may be included in the foregoing electronic device; or may exist separately and not assembled into the electronic device.

The computer-readable medium carries one or more programs therein. The foregoing one or more programs, when running on the terminal device, enable the terminal device to: acquire an initial panoramic multimedia material; present a first material track fragment on a video editing interface, wherein a video editing track is presented on the video editing interface, the first material track fragment is presented on the video editing track, and the first material track fragment is formed based on the initial panoramic multimedia material; in response to an editing instruction of setting an interaction event for a first video track fragment in the video editing interface, present, in the video editing interface, a track fragment corresponding to the interaction event, wherein the editing instruction is configured to indicate an interaction material of the interaction event, a timeline position, and at least one branch material, the interaction material is configured to indicate at least one branch option operation of the interaction event, different branch option operations in the at least one branch option operation are configured to trigger presentation of different branch materials in the at least one branch material respectively, the track fragment corresponding to the interaction event includes a second material track fragment and at least one third material track fragment, the second material track fragment is disposed at the timeline position, the second material track fragment is formed based on the interaction material, and the at least one third material track fragment is formed based on the at least one branch material respectively; and generate a target panoramic video based on the track fragment on the video editing track in the video editing interface.

Optionally, the foregoing one or more programs, when running on the terminal device, enable the terminal device to further perform other steps in the foregoing embodiments.

The computer-readable medium carries one or more programs therein. The foregoing one or more programs, when running on the terminal device, enable the terminal device to: play a panoramic video picture corresponding to a target panoramic video, wherein an interaction material of an interaction event, a timeline position, and at least one branch material are indicated, the interaction material is configured to indicate at least one branch option operation of the interaction event, different branch option operations in the at least one branch option operation are configured to trigger presentation of different branch materials in the at least one branch material respectively, a track fragment corresponding to the interaction event includes a second material track fragment and at least one third material track fragment, the second material track fragment is disposed at the timeline position, the second material track fragment is formed based on the interaction material, and the at least one third material track fragment is formed based on the at least one branch material respectively; and in response to the target panoramic video being played to the timeline position, display, in the panoramic video picture, the interaction material included in the interaction even; and in response to a trigger operation for the interaction material, present a video picture corresponding to a branch material that is associated with the interaction material and is included in the interaction event.

A computer program code for performing the operations of the present disclosure may be written in one or more programming languages or a combination thereof. The foregoing programming languages include, but are not limited to, object-oriented programming languages such as Java, Smalltalk, and C++, and further include conventional procedural programming languages such as the “C” language or similar programming languages. The program code may be executed entirely on the user's computer, partially on the user's computer, as a stand-alone software package, partially on the user's computer and partially on a remote computer, or entirely on a remote computer or server. In the case involving the remote computer, the remote computer may be connected to the user's computer via any type of network, including a LAN or a WAN, or may be connected to an external computer (e.g., using an internet service provider to connect over the internet).

Flowcharts and block diagrams in the accompanying drawings illustrate possible system architectures, functions, and operations of systems, methods, and computer program products according to various embodiments of the present disclosure. In this regard, each block in the flowchart or block diagram may represent a module, a program segment, or part of code that includes one or more executable instructions for implementing a specified logical function. It should also be noted that in some alternative implementations, functions marked in the block may also occur in different order than those marked in the accompanying drawings. For example, two blocks represented in succession may actually be executed in substantially parallel, and they may sometimes be executed in a reverse order, depending on the functions involved. It should also be noted that each block in the block diagram and/or flowchart and a combination of blocks in the block diagram and/or flowchart may be implemented by using a dedicated hardware-based system that performs a specified function or operation, or may be implemented by using a combination of dedicated hardware and a computer instruction.

The units described in the embodiments of the present disclosure may be implemented in a software fashion or may be implemented in a hardware fashion. The names of the units do not constitute a limitation to the units themselves in some cases.

The functions described above herein may be performed, at least in part, by one or more hardware logic components. For example, without limitation, example types of hardware logic components that can be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program for use by or in conjunction with an instruction execution system, apparatus or device. The machine-readable medium may be a machine-readable signal medium or a machine-readable storage medium. The machine-readable medium may include, but is not limited to, an electronic, magnetic, optical, electromagnetic, or semiconductor system, apparatus, or device, or any suitable combination thereof. More specific examples of the machine-readable storage medium include one or more wire-based electrical connections, portable computer disks, hard disks, RAMS, ROMs, EPROMs (or flash memories), optical fibers, CD-ROMs, optical storage devices, magnetic storage devices, or any suitable combination thereof.

According to one or more embodiments of the present disclosure, embodiments of the present disclosure provide a method for generating a panoramic video. The method includes: acquiring an initial panoramic multimedia material; presenting a first material track fragment on a video editing interface, wherein a video editing track is presented on the video editing interface, the first material track fragment is presented on the video editing track, and the first material track fragment is formed based on the initial panoramic multimedia material; in response to an editing instruction of setting an interaction event for a first video track fragment in the video editing interface, presenting, in the video editing interface, a track fragment corresponding to the interaction event, wherein the editing instruction is configured to indicate an interaction material of the interaction event, a timeline position, and at least one branch material, the interaction material is configured to indicate at least one branch option operation of the interaction event, different branch option operations in the at least one branch option operation are configured to trigger presentation of different branch materials in the at least one branch material respectively, the track fragment corresponding to the interaction event includes a second material track fragment and at least one third material track fragment, the second material track fragment is disposed at the timeline position, the second material track fragment is formed based on the interaction material, and the at least one third material track fragment is formed based on the at least one branch material respectively; and generating a target panoramic video based on the track fragment on the video editing track in the video editing interface.

According to one or more embodiments of the present disclosure, embodiments of the present disclosure provide a method for playing a panoramic video, wherein the panoramic video includes an initial panoramic multimedia material and an interaction event corresponding to the initial panoramic multimedia material. The method includes: playing a panoramic video picture corresponding to a target panoramic video, wherein an interaction material of the interaction event, a timeline position, and at least one branch material are indicated, the interaction material is configured to indicate at least one branch option operation of the interaction event, different branch option operations in the at least one branch option operation are configured to trigger presentation of different branch materials in the at least one branch material respectively, a track fragment corresponding to the interaction event includes a second material track fragment and at least one third material track fragment, the second material track fragment is disposed at the timeline position, the second material track fragment is formed based on the interaction material, and the at least one third material track fragment is formed based on the at least one branch material respectively; and in response to the target panoramic video being played to the timeline position, displaying, in the panoramic video picture, the interaction material included in the interaction even; and in response to a trigger operation for the interaction material, presenting a video picture corresponding to a branch material that is associated with the interaction material and is included in the interaction event.

According to one or more embodiments of the present disclosure, embodiments of the present disclosure provide an apparatus for generating a panoramic video. The apparatus includes: a panoramic multimedia material acquiring module configured to acquire an initial panoramic multimedia material; a video editing interface display module configured to present a first material track fragment on a video editing interface, wherein a video editing track is presented on the video editing interface, the first material track fragment is presented on the video editing track, and the first material track fragment is formed based on the initial panoramic multimedia material; an interaction event editing module configured to in response to an editing instruction of setting an interaction event for a first video track fragment in the video editing interface, present, in the video editing interface, a track fragment corresponding to the interaction event, wherein the editing instruction is configured to indicate an interaction material of the interaction event, a timeline position, and at least one branch material, the interaction material is configured to indicate at least one branch option operation of the interaction event, different branch option operations in the at least one branch option operation are configured to trigger presentation of different branch materials in the at least one branch material respectively, the track fragment corresponding to the interaction event includes a second material track fragment and at least one third material track fragment, the second material track fragment is disposed at the timeline position, the second material track fragment is formed based on the interaction material, and the at least one third material track fragment is formed based on the at least one branch material respectively; and a target panoramic video generating module configured to generate a target panoramic video based on the track fragment on the video editing track in the video editing interface.

According to one or more embodiments of the present disclosure, embodiments of the present disclosure provide an apparatus for playing a panoramic video, wherein the panoramic video includes an initial panoramic multimedia material and an interaction event corresponding to the initial panoramic multimedia material. The apparatus includes a panoramic video picture play module configured to play a panoramic video picture corresponding to a target panoramic video, wherein an interaction material of the interaction event, a timeline position, and at least one branch material are indicated, the interaction material is configured to indicate at least one branch option operation of the interaction event, different branch option operations in the at least one branch option operation are configured to trigger presentation of different branch materials in the at least one branch material respectively, a track fragment corresponding to the interaction event includes a second material track fragment and at least one third material track fragment, the second material track fragment is disposed at the timeline position, the second material track fragment is formed based on the interaction material, and the at least one third material track fragment is formed based on the at least one branch material respectively; an interaction material display module configured to in response to the target panoramic video being played to the timeline position, display, in the panoramic video picture, the interaction material included in the interaction even; and a branch material picture display module configured to in response to a trigger operation for the interaction material, present a video picture corresponding to a branch material that is associated with the interaction material and is included in the interaction event.

According to one or more embodiments of the present disclosure, embodiments of the present disclosure provide an electronic device. The electronic device includes:
one or more processors; and
a storage apparatus configured to store one or more programs, wherein
the one or more programs, when being executed by the one or more processors, enable the one or more processors to implement any foregoing method for generating the panoramic video or any foregoing method for playing the panoramic video.

According to one or more embodiments of the present disclosure, embodiments of the present disclosure provide a computer-readable storage medium, storing a computer program therein. The program, when being executed by a processor, implements any foregoing method for generating the panoramic video or any foregoing method for playing the panoramic video.

According to one or more embodiments of the present disclosure, embodiments of the present disclosure provide a computer program product. The computer program product includes a computer program or instruction, and the computer program or instruction, when being executed by a processor, implements any foregoing method for generating the panoramic video or any foregoing method for playing the panoramic video.

The foregoing description is only the description of preferred embodiments of the present disclosure and the used technical principle. A person skilled in the art should understand that in the present disclosure, the scope of the present disclosure is not limited to a technical solution formed by a specific combination of the above technical features and meanwhile should encompass other technical solutions formed by any combination of the foregoing technical features or equivalent features thereof without departing from the concept of the present disclosure, such as technical solutions formed by replacement among the foregoing features and the technical features having similar functions (however, the technical features are not limited thereto) disclosed in the present disclosure.

Furthermore, although operations are depicted in a specific order, this should not be interpreted as requiring these operations to be performed in the specific order shown or in a sequential order of execution. Multitasking and parallel processing may be advantageous in particular environments. In addition, while several specific implementation details are included in the above discussion, these should not be construed as limiting the scope of the present disclosure. Some features described in the context of separate embodiments may also be implemented in combination in a single embodiment. Conversely, various features described in the context of a single embodiment may also be implemented in multiple embodiments individually or in any suitable sub-combination.

Although the present subject matter has been described using language specific to structural features and/or method logical actions, it should be understood that the subject matter defined in the appended claims is not necessarily limited to the particular features or actions described above. Rather, the particular features and actions described above are merely example forms of implementing the claims.

1. A method for generating a panoramic video, comprising:
acquiring an initial panoramic multimedia material;
presenting a first material track fragment on a video editing interface, a video editing track being presented on the video editing interface, the first material track fragment being presented on the video editing track, and the first material track fragment being formed based on the initial panoramic multimedia material;
in response to an editing instruction of setting an interaction event for a first video track fragment in the video editing interface, presenting, in the video editing interface, a track fragment corresponding to the interaction event, wherein the editing instruction is configured to indicate an interaction material of the interaction event, a timeline position, and at least one branch material, the interaction material is configured to indicate at least one branch option operation of the interaction event, different branch option operations in the at least one branch option operation are configured to trigger presentation of different branch materials in the at least one branch material respectively, the track fragment corresponding to the interaction event comprises a second material track fragment and at least one third material track fragment, the second material track fragment is disposed at the timeline position, the second material track fragment is formed based on the interaction material, and the at least one third material track fragment is formed based on the at least one branch material respectively; and
generating a target panoramic video based on the track fragment on the video editing track in the video editing interface.

2. The method according to claim 1, wherein in response to the editing instruction of setting the interaction event for the first video track fragment in the video editing interface, presenting, in the video editing interface, the track fragment corresponding to the interaction event comprises:
in response to triggering an interactive event addition instruction for the first video track fragment in the video editing interface, adding, in the in the video editing interface, the second material track fragment corresponding to the interaction material in the interaction event; and
in response to a time selection operation for the second material track fragment in the video editing interface, acquiring a timeline position corresponding to the time selection operation as the timeline position corresponding to the second material track fragment.

3. The method according to claim 2, wherein in response to the editing instruction of setting the interaction event for the first video track fragment in the video editing interface, presenting, in the video editing interface, the track fragment corresponding to the interaction event comprises:
in response to a branch material selection operation for the second material track fragment in the video editing interface, acquiring a branch material corresponding to the branch material selection operation, and creating a third material track fragment corresponding to the branch material; and
establishing an association relationship between the branch material and the interaction material, such that the branch option operation indicated by the interaction material is configured to trigger presentation of the branch material corresponding to the third material track fragment.

4. The method according to claim 1, wherein in accordance with a determination that the interaction event is a voice interaction event, the interaction material is configured to indicate voice information that needs to be input by a user.

5. The method according to claim 1, wherein in accordance with a determination that the interaction event is a touch interaction event, the interaction material is configured to indicate an area that needs to be touched by a user.

6. The method according to claim 1, wherein in accordance with a determination that the interaction event is a gesture tracking interaction event, the interaction material is configured to indicate an action gesture that needs to be performed by a user.

7. The method according to claim 1, wherein generating the target panoramic video based on the track fragment on the video editing track in the video editing interface comprises:
in response to triggering of a generating operation for the target panoramic video in the video editing interface, generating the target panoramic video based on the track fragment on the video editing track in the video editing interface.

8. A method for playing a panoramic video, wherein the panoramic video comprises an initial panoramic multimedia material and an interaction event corresponding to the initial panoramic multimedia material, and the method comprises:
playing a panoramic video picture corresponding to a target panoramic video, wherein an interaction material of the interaction event, a timeline position, and at least one branch material are indicated, the interaction material is configured to indicate at least one branch option operation of the interaction event, different branch option operations in the at least one branch option operation are configured to trigger presentation of different branch materials in the at least one branch material respectively, a track fragment corresponding to the interaction event comprises a second material track fragment and at least one third material track fragment, the second material track fragment is disposed at the timeline position, the second material track fragment is formed based on the interaction material, and the at least one third material track fragment is formed based on the at least one branch material respectively; and
in response to the target panoramic video being played to the timeline position, displaying, in the panoramic video picture, the interaction material comprised in the interaction event; and
in response to a trigger operation for the interaction material, presenting a video picture corresponding to a branch material that is associated with the interaction material and is comprised in the interaction event.

9. The method according to claim 8, wherein before playing the panoramic video picture corresponding to the target panoramic video, the method further comprises:
acquiring a description file, and parsing the description file to acquire the initial panoramic multimedia material and the interaction event corresponding to the initial panoramic multimedia material.

10. The method according to claim 8, wherein the interaction event is a voice interaction event, and the method further comprises:
extracting semantic feature information from acquired voice information;
calculating a matching degree between the semantic feature information of the voice information and preset semantic feature information based on the semantic feature information of the voice information and the preset semantic feature information corresponding to the interaction material; and
in accordance with a determination that the matching degree is greater than a matching degree threshold, determining that the trigger operation for the interaction material occurs.

11. The method according to claim 8, wherein the interaction event is a gesture tracking interaction event, and the method further comprises:
recognizing an action gesture performed by a user; and
in response to a recognized current action gesture being a preset action gesture, receiving the trigger operation for the interaction material.

12. The method according to claim 8, wherein the interaction event is a touch interaction event, and the method further comprises:
in response to a touch operation for an area that needs to be touched by a user indicated by the interaction material, determining that the trigger operation for the interaction material occurs.

13. (canceled)

14. (canceled)

15. An electronic device, comprising:
one or more processors; and
a storage apparatus configured to store one or more programs,
the one or more programs, when executed by the one or more processors, causing the one or more processors to perform acts comprising:
acquiring an initial panoramic multimedia material;
presenting a first material track fragment on a video editing interface, a video editing track being presented on the video editing interface, the first material track fragment being presented on the video editing track, and the first material track fragment being formed based on the initial panoramic multimedia material;
in response to an editing instruction of setting an interaction event for a first video track fragment in the video editing interface, presenting, in the video editing interface, a track fragment corresponding to the interaction event, wherein the editing instruction is configured to indicate an interaction material of the interaction event, a timeline position, and at least one branch material, the interaction material is configured to indicate at least one branch option operation of the interaction event, different branch option operations in the at least one branch option operation are configured to trigger presentation of different branch materials in the at least one branch material respectively, the track fragment corresponding to the interaction event comprises a second material track fragment and at least one third material track fragment, the second material track fragment is disposed at the timeline position, the second material track fragment is formed based on the interaction material, and the at least one third material track fragment is formed based on the at least one branch material respectively; and
generating a target panoramic video based on the track fragment on the video editing track in the video editing interface.

16. (canceled)

17. (canceled)

18. The electronic device according to claim 15, wherein in response to the editing instruction of setting the interaction event for the first video track fragment in the video editing interface, presenting, in the video editing interface, the track fragment corresponding to the interaction event comprises:
in response to triggering an interactive event addition instruction for the first video track fragment in the video editing interface, adding, in the in the video editing interface, the second material track fragment corresponding to the interaction material in the interaction event; and
in response to a time selection operation for the second material track fragment in the video editing interface, acquiring a timeline position corresponding to the time selection operation as the timeline position corresponding to the second material track fragment.

19. The electronic device according to claim 18, wherein in response to the editing instruction of setting the interaction event for the first video track fragment in the video editing interface, presenting, in the video editing interface, the track fragment corresponding to the interaction event comprises:
in response to a branch material selection operation for the second material track fragment in the video editing interface, acquiring a branch material corresponding to the branch material selection operation, and creating a third material track fragment corresponding to the branch material; and
establishing an association relationship between the branch material and the interaction material, such that the branch option operation indicated by the interaction material is configured to trigger presentation of the branch material corresponding to the third material track fragment.

20. The electronic device according to claim 15, wherein in accordance with a determination that the interaction event is a voice interaction event, the interaction material is configured to indicate voice information that needs to be input by a user.

21. The electronic device according to claim 15, wherein in accordance with a determination that the interaction event is a touch interaction event, the interaction material is configured to indicate an area that needs to be touched by a user.

22. The electronic device according to claim 15, wherein in accordance with a determination that the interaction event is a gesture tracking interaction event, the interaction material is configured to indicate an action gesture that needs to be performed by a user.

23. The electronic device according to claim 15, wherein generating the target panoramic video based on the track fragment on the video editing track in the video editing interface comprises:
in response to triggering of a generating operation for the target panoramic video in the video editing interface, generating the target panoramic video based on the track fragment on the video editing track in the video editing interface.
